(19) United States
(12) Patent Application Publication
(10) Pub. No.: US 2010/0055016 A1
(43) Pub. Date: Mar. 4, 2010

(54) METHOD OF MANUFACTURING OXIDE-BASED NANO-STRUCTURED MATERIAL

(76) Inventors: Sang-Hyeob Kim, Daejeon-city (KR); Hye-Jin Myoung, Daejeon-city (KR); Sung-Lyul Maeng, Chungcheongbuk-do (KR); G.A.J. Amaratunga, Cambridge (GB); Sunyoung Lee, Seoul (KR)

Correspondence Address: AMPACC Law Group, 3500 188th Street S.W., SUITE 103, Lynnwood, WA, 98037, US

(21) Appl. No.: 12/531,782

(22) PCT Filed: Feb. 1, 2008
(86) PCT No.: PCT/KR08/00624

§ 371 Date: Sep. 17, 2009

(30) Foreign Application Priority Data
Mar. 28, 2007 (KR) 10-2007-0030357

(51) Int. Cl. C01G 9/02; C01B 13/32; C01G 25/02; C01G 27/02; C01G 23/04; C01G 37/02; C01G 45/02; C01G 47/00; C01G 99/00; C01G 49/02; C01G 53/00; C01G 51/04; C01G 3/02; C01G 5/00; C01G 7/00; C01F 17/00; C01G 33/00; C01G 35/00; C01G 41/02; C01G 39/02; C01G 13/02; C01G 11/00; C01G 56/00; C01B 15/14; C01G 19/02; C01G 17/00; C01G 28/00; C01G 29/00; C01G 30/00; C01G 15/00

(52) U.S. Cl. 423/249; 423/592.1; 423/608; 423/607; 423/605; 423/632; 423/594.19; 423/604; 423/622; 423/263; 423/594.17; 423/606; 423/594.18; 423/325; 423/618; 423/617; 423/624

(57) ABSTRACT

Provided is a method of manufacturing oxide-based nano-structured materials using a chemical wet process, and thus, the method can be employed to manufacture oxide-based nano-structured materials having uniform composition and good electrical characteristics in large quantities, the method having a relatively simple process which does not use large growing equipment. The method includes preparing a first organic solution that comprises a metal, mixing the first organic solution with a second organic solution that contains hydroxyl radicals (—OH), filtering the mixed solution using a filter in order to extract oxide-based nano-structured materials formed in the mixed solution, drying the extracted oxide-based nano-structured materials to remove any remaining organic solution, and heat treating the dried oxide-based nano-structured materials.

### TECHNICAL FIELD

The present invention relates to a method of manufacturing a nano-structured material, and more particularly, to a method of manufacturing oxide-based nano-structured materials in large quantities using a wet method.

The present invention was supported by the Information Technology (IT) Research & Development (R & D) program of the Ministry of Information and Communication (MIC) [project No. 2005-S-605-02, project title: IT-BT-NT Convergent Core Technology for advanced Optoelectronic Devices and Smart Bio/Chemical Sensors].

### BACKGROUND ART

Oxide-based nano-structured materials that include transition metals and semi-metal elements have potential applications in a wide range of fields, for example, nano-electronic devices (such as field effect transistors (FETs), single electron transistors (SETs), photodiodes, and biochemical sensors), solar cells, or display fields, and thus, a large amount of research has been conducted thereon.

Oxide-based nano-structured materials that have semiconductor characteristics can be applied to the fields of photoelectronic devices or gas sensors. Examples of the oxide-based nano-structured materials are ZnO and SnO₂ having band gaps of 3.37 eV and 3.6 eV respectively. In particular, SnO₂ can be applied to transparent electrode materials since SnO₂ has a short wavelength and exhibits low voltage operation characteristics.

A conventional method of forming an oxide-based nano-structured material will now be described. A novel metal, for example, Au, Ag, Pd, or Pt is formed to a thin film of a nano-size on a substrate using a sputtering method or a thermal evaporation method. Afterwards, the thin film is heat treated to form novel metal particles or novel metal clusters of a size of a few nanometers. Next, oxide-based nano-structured materials are grown around the nano particles or the nano clusters using a physical and chemical deposition method, for example, a metal organic chemical vapor deposition (MOCVD) method, a vapor liquid solid epitaxial (VSLE) method, a pulsed laser deposition (PLD) method, or a sol-gel process. In particular, in order to stably grow the oxide-based nano-structured materials, a MOCVD method, a VSLE method, or a PLD method that can be performed at a high temperature, for example, around 500° C., is employed. However, the conventional method of forming the oxide-based nano-structured materials is complicated, requires a large area of substrate, requires large growing equipment, and is difficult to produce in large quantities. Also, there is a possibility that joining between the novel metal nano-particles that act as growing cores and the oxide-based nano-structured materials can be instable, or the injection of a doping element can be difficult. In particular, despite the fact that a material that constitutes the nano-structure has good electrical characteristics, the composition of the generated nano-structures may be non-uniform and the shape and size of the nano-structures may be non-uniform, and thus, the produced oxide-based nano-structured materials can have instable electrical characteristics. Therefore, it is difficult to apply the oxide-based nano-structured materials to electronic devices such as bonding thin film transistors and optoelectronic devices.

### DISCLOSURE OF INVENTION

### Technical Problem

To solve the above and/or other problems, the present invention provides a simple and economical method of manufacturing oxide-based nano-structured materials having uniform electrical characteristics in large quantities.

### Technical Solution

According to an aspect of the present invention, there is provided a method of manufacturing oxide-based nano-structured materials, comprising: preparing a first organic solution that comprises a metal; mixing the first organic solution with a second organic solution that contains hydroxyl radicals (—OH); filtering the mixed solution using a filter in order to extract oxide-based nano-structured materials formed in the mixed solution; drying the extracted oxide-based nano-structured materials to remove any remaining organic solution; and heat treating the dried oxide-based nano-structured materials.

The metal may be one selected from the group consisting of Sc, Ti, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, lanthanide, actinoid, Si, Ge, Sn, As, Sb, Bi, Ga, and In.

The second organic solution may be one selected from the group consisting of methanol CH₃OH, ethanol C₂H₅OH, ethylene glycol C₂H₄(OH), glycerol C₃H₅(OH), propanol C₃H₇OH, butanol C₄H₉OH, phenol C₆H₅OH, C₆H₄(OH)₂, cresol C₆H₄(CH₃)OH, pyrogallol C₆H₃(OH)₃, and naphthol C₁₀H₇(OH).

The mixing operation may further comprise stirring the mixed solution and preserving the mixed solution without further mixing.

In the mixing operation, the mixing ratio of the first organic solution and the second organic solution may be in a range of from 1:1 to 1:50000.

The stirring operation, the preserving operation, and the filtering operation may be performed at a temperature range of from 50° C. to 300° C. for a time range of from 1 second to 24 hours.

The filtering operation may comprise extracting the manufactured oxide-based nano-structured materials according to sizes thereof using a plurality of filters having different sizes of pores.

The drying operation may be performed at a temperature range of from 50° C. to 500° C. for a time range of from 1 second to 24 hours.

The heat treatment operation may be performed at a temperature range of from 100° C. to 1200° C. for a time range of from 1 second to 24 hours.

The heat treatment operation may be performed under a vacuum state, an inert gas atmosphere, an oxidative gas atmosphere, or a reductive gas atmosphere.

Hereinafter, related techniques related to the method of manufacturing oxide-based nano-structured materials will now be described.

### REFERENCE TECHNIQUE 1

Li, Jun et al., U.S. Patent Publication No. 20030189202 (Oct. 9, 2003), “Nanowire devices and methods of fabrication,”

In the reference technique 1, after forming patterned catalyst positions on a substrate formed of silicon, carbon nanotubes (CNTs) or monocrystal semiconductor nano-wires are grown on the catalyst positions using a chemical vapor deposition (CVD) method. When the present invention is compared to the reference technique 1, the present invention does not use a substrate and a catalyst.

### REFERENCE TECHNIQUE 2

F. Xu et al, “A low-temperature aqueous solution route to large-scale growth of ZnO nanowire arrays,” Journal of non-crystalline solids, pp. 2569-2574, 2006.

In the reference technique 2, dense ZnO nano-wires having fewer defects are grown using a low temperature (60° C.) solution on a Zn thin film substrate in an autoclave. In order to extract the nano-wires formed in this way, a complicated process such as scratch out must be used. When the present invention is compared to the reference technique 2, the present invention does not require equipment like the autoclave and the extraction of the formed nano-wires is simpler since the present invention does not use a substrate.

### REFERENCE TECHNIQUE 3

M. J. Zheng et al, “Fabrication and optical properties of large-scale uniform zinc oxide nanowire arrays by one-step electrochemical deposition technique,” Chemical Physics Letters, no. 363, pp. 123-128, 2002.

In the reference technique 3, ZnO nano-wires are formed in a zinc nitrate solution by an electrochemical method using an electrode formed by sputtering Au on a nano-sized amorphous alumina membrane (AAM). This process is economical and can be performed at a low temperature. Also, in this process, nano-wires of different metal oxides can be formed. When the present invention is compared to the reference technique 3, the present invention can manufacture the nano-structures in large quantities without using the AAM using a more simple process. Also, the present invention can manufacture ZnO nano-wires having further improved optical characteristics compared to the reference technique 3, and thus, stable optoelectronic devices can be manufactured.

### REFERENCE TECHNIQUE 4

Q. Wan et al, “Room-temperate hydrogen storage characteristics of ZnO nanowires,” Applied Physics Letters, vol. 84, pp. 124-126, 2004.

In the reference technique 4, ZnO nano-wires having a diameter of 20 nm are manufactured using evaporation of metal zinc by flowing argon gas in a quartz tube which is preserved at a temperature of 900° C. This method manufactures the ZnO nano-wires using a dry method without using a metal catalyst or a carbon addition material under a non-vacuum atmosphere. When the present invention is compared to the reference technique 4, the present invention uses a wet method and does not require equipment such as the quartz tube, and thus, the ZnO nano-wires can be manufactured large quantities using relatively simple and compact equipment, and in particular, it is easier to manufacture optoelectronic devices and biochemistry sensor devices.

### ADVANTAGEOUS EFFECTS

The method of manufacturing oxide-based nano-structured materials according to the present invention can be employed to manufacture oxide-based nano-structured materials using a chemical wet process, and thus, oxide-based nano-structured materials having uniform composition and electrical characteristics can be manufactured in large quantities using a relatively simple process without use of large growing equipment. In particular, in the method of manufacturing oxide-based nano-structured materials according to the present invention, a substrate is not used for growing nano-structures. Thus, problems caused due to crystallographical incoherence between a substrate and the nano-structures can be prevented. The oxide-based nano-structured materials manufactured using the method described above can be widely used in the fields such as nano-electronic devices, for example, FETs, SETs, photodiodes, biochemical sensors, or logic circuits, solar cells, or display fields.

### DESCRIPTION OF DRAWINGS

The above and other features and advantages of the present invention will become more apparent by describing in detail exemplary embodiments thereof with reference to the attached drawings in which:

FIG. 1 is a flow chart showing a method of manufacturing oxide-based nano-structured materials according to an embodiment of the present invention;

FIG. 2 is a field emission scanning electron microscopy (FESEM) image of ZnO nano-wires manufactured using a method according to an embodiment of the present invention; and

FIG. 3 is a graph showing a photoluminescence (PL) spectrum of heat treated ZnO nano-wires manufactured using a method according to an embodiment of the present invention.

### BEST MODE

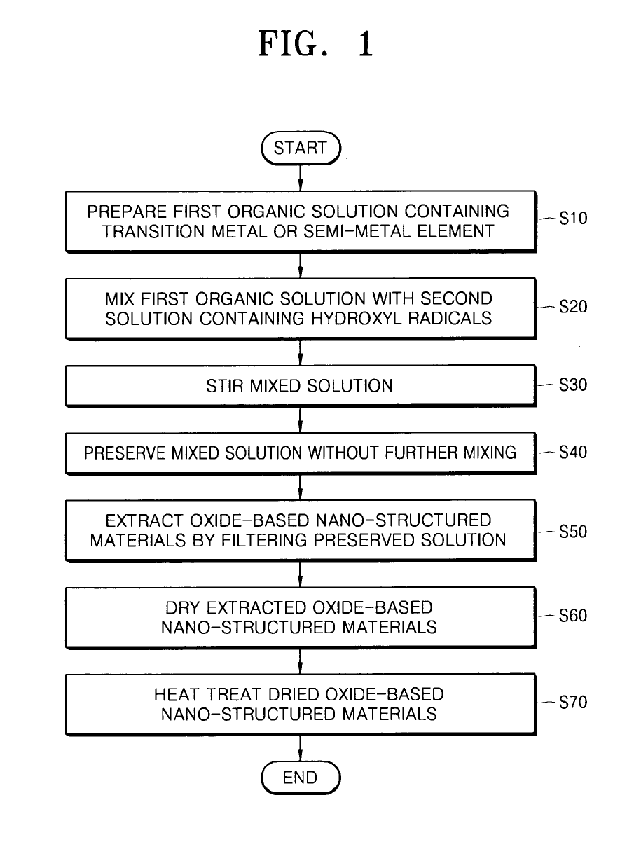

As shown in FIG. 1, a first organic solution that includes a metal element, for example, a transition metal or a semi-metal element is prepared (S10). The first organic solution is mixed with a second organic solution that includes —OH radicals (S20). The mixed solution of the first organic solution and the second organic solution are stirred (S30). The mixed solution is preserved without further mixing (S40). The mixed solution is filtered to extract the precipitated oxide-based nano-structured materials in the mixed solution (S50). In order to remove any remaining organic solvent, the filtered oxide-based nano-structured materials are dried (S60). The dried oxide-based nano-structured materials are heat treated so that the oxide-based nano-structured materials can have a stable structure and a uniform composition (S70).

### Mode for Invention

The present invention will now be described more fully with reference to the accompanying drawings in which exemplary embodiments of the invention are shown.

These embodiments are provided so that this disclosure will be thorough and complete, and will fully convey the concept of the invention to those skilled in the art. The invention may, however, be embodied in many different forms and should not be construed as being limited to the embodiments set forth herein.

FIG. 1 is a flow chart showing a method of manufacturing oxide-based nano-structured materials according to an embodiment of the present invention.

Referring to FIG. 1, a first organic solution that includes a metal element, for example, a transition metal or a semi-metal element is prepared (S10). The transition metal or the semi-metal element must be configured to a structure that can be dissolved in the first organic solvent, and thus, the first organic solvent can be, for example, M(CH₃COO)₂.2H₂O, where M is a transition metal or a semi-metal element. However, this is an example and the solvent according to the present invention is not limited thereto. If the metal element is a transition metal, the transition metal can be one selected fro the group consisting of Sc, Ti, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, lanthanide, and actinoid. If the metal element is a semi-metal, the semi-metal can be one selected from the group consisting of Si, Ge, Sn, As, Sb, Bi, Ga, and In. Next, the first organic solution is mixed with a second organic solution that includes —OH radicals (S20). The second organic solution can be one selected from the group consisting of methanol CH₃OH, ethanol C₂H₅OH, ethylene glycol C₂H₄(OH)₂, glycerol C₃H₅(OH)₃, propanol C₃H₇OH, butanol C₄H₉OH, phenol C₆H₅OH, C₆H₄(OH)₂, cresol C₆H₄(CH₃)OH, pyrogallol C₆H₃(OH)₃, and naphthol C₁₀H₇(OH). The mixing ratio of the first organic solution to the second organic solution may be 1:1 to 1:50000.

The mixed solution of the first organic solution and the second organic solution are stirred (S30). The stirring operation can be performed by a conventional stirring method. For example, the mixture can be stirred using a stirrer such as a bar or using ultrasonic waves. Through the stirring, the first organic solution and the second organic solution can further be mixed, and also, the forming of the metal oxides can further be facilitated by combining the metal element included in the first organic solution with oxygen included in the hydroxyl radials of the second organic solution. The stirring operation is optional, thus, may be omitted. Also, the stirring time and temperature may vary according to the kind of metal element, and also may vary according to the kind of the first organic solution, the kind of the second organic solution, and the mixing ratio of the first and second organic solutions. For example, at temperature in a range of from 50° C. to 300° C., the stirring can be performed for a time range of from 1 second to 24 hours.

Next, the mixed solution is preserved without further mixing (S40). In the preserving operation, nano-sized metal oxides can be formed by combining the metal elements with oxygen atoms as in the stirring operation described above. Conventionally, the metal oxides are not dissolved in an organic solution, but are floated, dispersed, or precipitated in the organic solution. Through the preserving operation, formed metal oxides are precipitated. Hereinafter, the metal oxides are referred to as oxide-based nano-structured materials. The preserving operation is optional, and thus, may be omitted if it is unnecessary. Also, the preserving time and temperature may vary according to the kind of metal element and kinds and density of the formed metal oxides, and also may vary according to the kind of the first organic solution, the kind of the second organic solution, and the mixing ratio of the first and second organic solutions. For example, at temperature in a range of from 50° C. to 300° C., the preserving can be performed for a time range of from 1 second to 24 hours. The temperature for stirring operation and preserving operation may not be the same.

Next, the mixed solution is filtered to extract the precipitated oxide-based nano-structured materials in the mixed solution (S50). As described above the extracted oxide-based nano-structured materials are formed by combining metal elements with oxygen elements. The metal elements, for example, transition metal elements or semi-metal elements are included in the first organic solution, and the oxygen elements are included in the hydroxyl radical of the second organic solution. The oxide-based nano-structured materials can be expressed in a chemical equation as MₓO_{y}, where x and y are chemical stoichiometric ratios formed between M (a metal element) and O (oxygen atom).

The filtering temperature and time may vary according to the shape and size of the oxide-based nano-structured materials, for example, may be performed at temperature in a range of from 50° C. to 300° C. for a time range of from 1 second to 24 hours. Also, in the filtering operation, the formed oxide-based nano-structured materials can be extracted according to the sizes of the oxide-based nano-structured materials by using a plurality of filters having different pore sizes.

Next, in order to remove any remaining organic solvent, the filtered oxide-based nano-structured materials are dried (S60). The drying time and temperature may vary according to the kind, quantity, and size of the oxide-based nano-structured materials. For example, the drying operation can be performed at temperature in a range of from 50° C. to 500° C. for a time range of from 1 second to 24 hours. Also, the drying operation can be performed under an air atmosphere, an inert gas atmosphere, such as argon, or a vacuum state.

Next, the dried oxide-based nano-structured materials are heat treated so that the oxide-based nano-structured materials can have a stable structure and a uniform composition (S70). The heat treating temperature and time may vary according to the kind, quantity, and size of the oxide-based nano-structured materials. For example, the heat treating can be performed at temperature in a range of from 100° C. to 1200° C. for a time range of from 1 second to 24 hours. Also, the heat treating operation can be performed under a vacuum state or an inert gas atmosphere such as argon. Alternatively, the heat treating can also be performed under an oxidative gas atmosphere such as oxygen gas or a reductive gas atmosphere such as hydrogen gas.

Also, the entire the operations or a part of the operations described above, that is, the mixing operation (S20), the stirring operation (S30), the preserving operation (S40), the filtering operation (S50), and the heat treating operation (S60) can be consecutively performed. That is, the oxide-based nano-structured materials can be formed by performing the above operations while a container in which the mixture solution is contained is moving on a moving means such as a conveyor belt through process regions designed to perform each of the operations described above. Otherwise, the operations can be performed by mounting a container designed to perform the above operation, for example, in a chamber. That is, the container can include a first region in which the mixing operation (S20), the stirring operation (S30), and the preserving operation (S40) can be performed, a second region in which the filtering operation (S50) can be performed, and a gate that is opened and closed to connect and disconnect the first region and the second region. Thus, after performing the mixing operation (S20), the stirring operation (S30), and the preserving operation (S40) of the mixed solution injected into the first region of the container, the mixed solution is moved to the second region by opening the gate. Afterwards, the filtering operation (S50) is performed. Also, after performing the filtering operation (S50), the drying operation (S60) and the heat treating operation (S70) can be performed in the second region or in a third region further included in the container. However, this is an example, and thus, the present invention is not limited thereto.

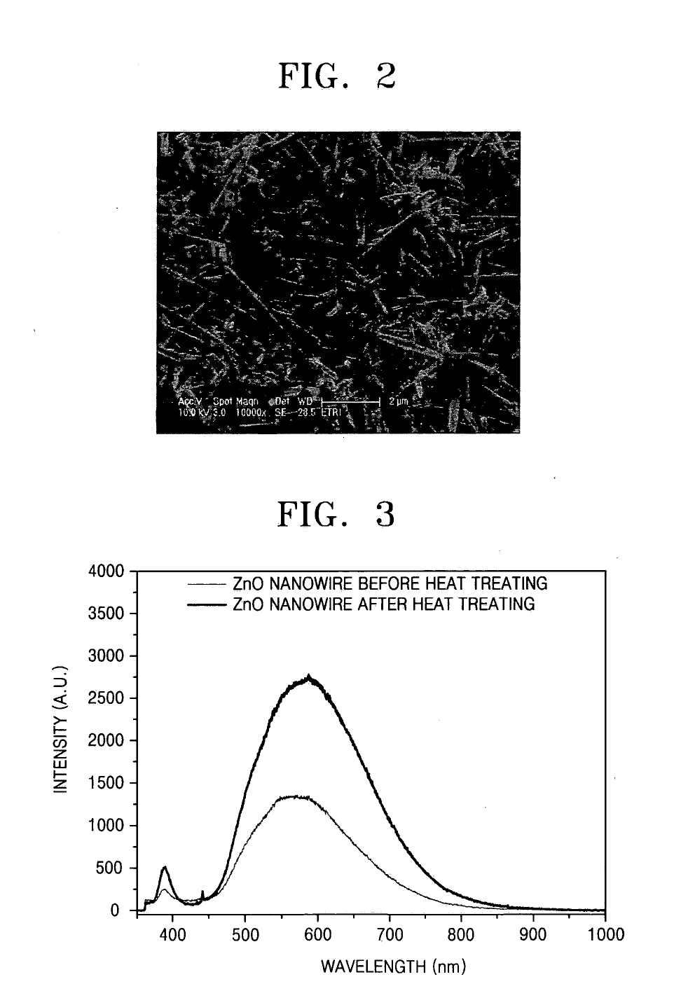

FIG. 2 is a field emission scanning electron microscopy (FESEM) image of ZnO nano wires manufactured using a method according to an embodiment of the present invention.

Referring to FIG. 2, ZnO nano-wires having relatively uniform thickness can be formed in large quantities using the method of manufacturing oxide-based nano-structured materials according to the present invention. The manufactured ZnO nano-wires have different lengths. The shapes and lengths of the nano-wires can be controlled by controlling various process variables. For example in order to form uniform nuclei, nano-sized nuclei can be mixed when precipitators are formed, or if stirring temperature, stirring speed, stirring times, stirring time, and stirring method are varied, uniform nano-wires of other dimensions can be obtained. Also, relatively uniform nano-particles having certain directivity can be manufactured if the precipitators are grown with certain directivity by applying, for example, an electromagnetic field after generating nuclei of the precipitators.

As described above, the oxide-based nano-structured materials manufactured using the method according to the present invention can have various shapes, such as nanoparticles, nanorods, nanowires, nanowalls, nanotubes, nanobelts, or nanorings.

In the reference techniques described above, in order to manufacture nano-structures, a substrate is used, and manufactured nano-structures are chemically or crystallographically combined with the substrate. However, in the method of manufacturing oxide-based nano-structured materials according to the present invention, a substrate is not used and the manufactured oxide-based nano-structured materials are not chemically or crystallographically combined with a filter used in a filtering process. Thus, relatively readily separated from the filter, and also, there is no damage to the nano-structured materials due to the separation process.

FIG. 3 is a graph showing a photoluminescence (PL) spectrum of heat treated ZnO nano-wires manufactured using a method according to an embodiment of the present invention.

Referring to FIG. 3, the PL strength of the heat treated ZnO nano-wires is significantly increased at a wavelength of approximately 580 nm and 380 nm. The improvement of optical characteristics of the heat treated ZnO nano-wires denotes that the ZnO nano-wires are stabilized through heat treatment and have a relatively uniform composition.

The method of manufacturing oxide-based nano-structured materials according to the present invention includes: a chemical wet process in which an organic solution that includes a transition metal or a semi-metal element is mixed with another organic solution and oxide-based nano-structured materials are grown through a chemical reaction accompanied by the mixing of the two solutions; and a physical dry process in which the grown oxide-based nano-structured materials are controlled to have a uniform composition and to have stable structure. In the method of manufacturing oxide-based nano-structured materials according to the present invention, novel metal nano-particles that are used as a catalyst in a conventional physical method of manufacturing the oxide-based nano-structured materials are not used. Thus, the difficulty of combining a substrate with the nano-structures and the difficulty of injecting doping atoms of the conventional art can be removed. The method according to the present invention can be employed to manufacture oxide-based nano-structured materials having a uniform composition, a uniform shape, and a uniform size. Thus, the oxide-based nano-structured materials can have stable optical and electrical characteristics. Also, the method according to the present invention can manufacture the oxide-based nano-structured materials in large quantities. The oxide-based nano-structured materials manufactured as described above can be used in various fields such as bio sensors/chemical sensor devices, solar cells, light emitting diodes (LEDs), or display devices.

The method of manufacturing oxide-based nano-structured materials according to the present invention can be employed to manufacture oxide-based nano-structured materials using a chemical wet process, and thus, oxide-based nano-structured materials having uniform composition and electrical characteristics can be manufactured in large quantities using a relatively simple process without use of large growing equipment. In particular, in the method of manufacturing oxide-based nano-structured materials according to the present invention, a substrate is not used for growing nano-structures. Thus, problems caused due to crystallographical incoherence between a substrate and the nano-structures can be prevented. The oxide-based nano-structured materials manufactured using the method described above can be widely used in the fields such as nano-electronic devices, for example, FETs, SETs, photodiodes, biochemical sensors, or logic circuits, solar cells, or display fields.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of manufacturing oxide-based nano-structured materials, comprising:
preparing a first organic solution that comprises a metal;
mixing the first organic solution with a second organic solution that contains hydroxyl radicals (—OH);
filtering the mixed solution using a filter in order to extract oxide-based nano-structured materials formed in the mixed solution;
drying the extracted oxide-based nano-structured materials to remove any remaining organic solution; and
heat treating the dried oxide-based nano-structured materials.

2. The method of claim 1, wherein the metal is one selected from the group consisting of Sc, Ti, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, lanthanide, actinoid, Si, Ge, Sn, As, Sb, Bi, Ga, and In.

3. The method of claim 1, wherein the second organic solution is one selected from the group consisting of methanol CH₃OH, ethanol C₂H₅OH, ethylene glycol C₂H₄(OH)₂, glycerol C₃H₅(OH)₃, propanol C₃H₇OH, butanol C₄H₉OH, phenol C₆H₅OH, C₆H₄(OH)₂, cresol C₆H₄(CH₃)OH, pyrogallol C₆H₃(OH)₃, and naphthol C₁₀H₇(OH).

4. The method of claim 1, wherein the mixing operation further comprises:
stirring the mixed solution; and
preserving the mixed solution without further mixing.

5. The method of claim 1, wherein, in the mixing operation, the mixing ratio of the first organic solution and the second organic solution is in a range of from 1:1 to 1:50000.

6. The method of claim 4, wherein the stirring operation is performed at a temperature range of from 50° C. to 300° C. for a time range of from 1 second to 24 hours.

7. The method of claim 4, wherein the preserving operation is performed at a temperature range of from 50° C. to 300° C. for a time range of from 1 second to 24 hours.

8. The method of claim 1, wherein the filtering operation is performed at a temperature range of from 50° C. to 300° C. for a time range of from 1 second to 24 hours.

9. The method of claim 1, wherein the filtering operation comprises extracting the manufactured oxide-based nano-structured materials according to sizes thereof using a plurality of filters having different sizes of pores.

10. The method of claim 1, wherein the drying operation is performed at a temperature range of from 50° C. to 500° C. for a time range of from 1 second to 24 hours.

11. The method of claim 1, wherein the heat treating is performed at a temperature range of from 100° C. to 1200° C. for a time range of from 1 second to 24 hours.

12. The method of claim 1, wherein the heat treating operation is performed under a vacuum state, an inert gas atmosphere, an oxidative gas atmosphere, or a reductive gas atmosphere.
